(19) United States
(12) Patent Application Publication
(10) Pub. No.: US 2005/0252347 A1
(43) Pub. Date: Nov. 17, 2005

(54) Surgical wrench

(76) Inventors: Ed Austin, Bartlett, TN (US); Johnny Mason, Memphis, TN (US); Carlos Rodriguez, Gleason, TN (US)

Correspondence Address: CHIEF PATENT COUNSEL;SMITH & NEPHEW, INC., 1450 BROOKS ROAD, MEMPHIS, TN, 38116, US

(21) Appl. No.: 11/129,120

(22) Filed: May 13, 2005

Related U.S. Application Data
(60) Provisional application No. 60/570,558, filed on May 13, 2004.

(51) Int. Cl. B25B 13/46

(52) U.S. Cl. 81/60

(57) ABSTRACT

A surgical wrench that facilitates the adjustment of orthopaedic surgical instruments, implants or other structures or devices with little to no doubt as to the turning direction that will be applied by the surgical wrench.

### RELATED APPLICATIONS

This non-provisional application claims the benefit of U.S. Ser. No. 60/570,588, entitled “Fail Safe Orthopedic Wrench” and filed May 13, 2004, the entire contents of which are hereby incorporated by this reference.

### BACKGROUND

When performing surgical operations and procedures, including orthopaedic and trauma related procedures, time and accuracy is of the essence. Orthopaedic, trauma and other surgical tools, instruments and implants may require tightening, loosening or other types of adjustments during the surgical procedure. For example, in some surgical procedures, it is necessary to tighten a bolt or other type of fastening, retaining or other type of adjustment mechanism to affix various components in a defined relationship or otherwise configure an item for the procedure at hand. To properly tighten a typical bolt, it must be turned in the correct direction (e.g., clockwise or counterclockwise). In the stressful environment of an operating room, especially when the various components (such as clamps, saw guides, insertion guides, implant components, internal or external fixation components, etc. . . . ) are located in several different orientations and positions, it can be difficult to quickly and accurately determine the correct rotation direction for tightening or loosening the fastener or retaining mechanism.

Occasionally, turning the fastener or other type of adjustment mechanism in the wrong direction can have undesired results, including moving a component or other item out of proper alignment (resulting in wasted time to re-align) or even damaging one or more of the components or other items.

Typical wrenches used for adjusting various items during a surgical procedure generally have a bidirectional ratcheting capability wherein the user selects the desired direction of the ratcheting action, which in turn will determine whether the fastener is turned in a clockwise or counterclockwise direction, which in turn will either tighten or loosen the bolt or other fastener. The typical ratcheting wrench will include either a switch or a flipper for selecting the ratcheting direction. Often, the user will select the wrong ratcheting direction, resulting in an unintended rotation of the fastener, which, as discussed above, can have undesired results.

Thus, there is a need for a tool wherein the user can quickly and accurately determine whether the fastener or other adjustment mechanism will be tightened or loosened or otherwise adjusted.

### SUMMARY

Embodiments of the present invention provide a surgical wrench that may facilitate the tightening, loosening or other adjustment of components associated with orthopaedic surgical instruments, implants or other structures or devices with little to no doubt as to the turning direction that will be applied by the surgical wrench to the component. Various embodiments of the present invention may include a ratchet mechanism disposed at an end of the wrench or at another location that may be configured to ratchet in one direction only (i.e. it is not selectively reversible). Also, the ratcheting mechanism may be configured to allow only one possible direction of application such that the device cannot be inverted and applied in a way as to reverse the ratchet action. Associated with the ratcheting mechanism may be structure for temporarily engaging the component to be tightened, loosened or otherwise adjusted. Indicia may be associated with the wrench to indicate the direction of adjustment that may be accomplished using that particular ratcheting mechanism.

Wrenches in accordance with embodiments the present invention may be used to apply an external fixator to a patient. In some embodiments, using a “tighten” wrench the surgeon may quickly and confidently tighten all of the fixation clamps without having to contemplate their direction or orientation. In other embodiments, a surgeon may use a wrench in accordance with embodiments of the present invention to adjust a cutting guide or drill guide for some other surgical application.

### BRIEF DESCRIPTION OF DRAWINGS

FIG. 1 shows a top plan view of a surgical wrench according to a first embodiment of the present invention.

FIG. 2 shows a side view of the surgical wrench shown in FIG. 1.

FIG. 3 shows a side view of a surgical wrench according to another embodiment of the present invention.

FIG. 4 shows a top plan view of the surgical wrench of FIG. 3.

FIG. 5a shows schematically indicia for use on surgical wrenches according to another embodiment of the present invention.

FIG. 5b shows schematically indicia for use on surgical wrenches according to another embodiment of the present invention.

FIG. 5c shows schematically indicia for use on surgical wrenches according to another embodiment of the present invention.

### DETAILED DESCRIPTION OF DRAWINGS

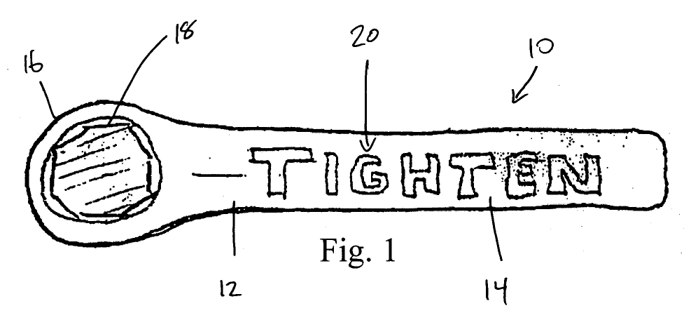

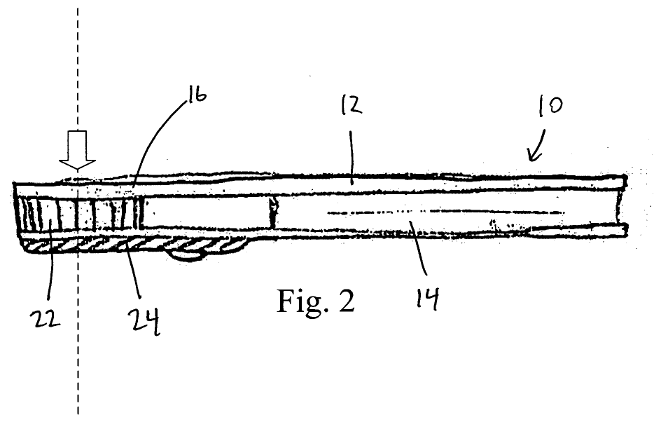

FIG. 1 shows a surgical wrench 10 according to a first embodiment of the present invention. The surgical wrench 10 shown in FIG. 1 may include a body 12, a handle 14, a head 16, a socket 18 and indicia 20. As shown best in FIG. 2, the surgical wrench of FIGS. 1 and 2 may also include, a ratcheting mechanism 22 and a cover plate 24. In other embodiments of the present invention, not all of these components and features are necessary. Other embodiments of the present invention may include other combinations of the above identified features and components, varying numbers of each of the above features and components and other features and components not identified above.

The ratcheting mechanism 22 and socket 18 of the wrench 10 shown in FIG. 1 are disposed proximate the wrench's head 16. In other embodiments, the ratcheting mechanism 22 and socket 18 may be disposed in any other location on the surgical wrench 10, including medial locations.

The ratcheting mechanism 22 shown in the embodiment of FIG. 1 is not reversible. In other words, the ratcheting mechanism 22 shown in FIG. 1 only permits the socket 18 to rotate with respect to the wrench 10 in one direction, either clockwise or counter-clockwise but not both. In other embodiments, ratcheting mechanism 22 is not necessary. Rather, any other mechanism could be employed with the present invention that allows the socket 18 to only rotate in one direction.

The socket 18 shown in FIG. 1 is shaped and sized to engage the head of a correspondingly shaped and sized bolt. In the embodiment shown in FIG. 1, the socket is an octagonal socket having eight sides. However, in other embodiments, the socket can be shaped and sized to engage any desired fastener or other structure. For example, sockets in accordance with the present invention may be six sided to engage “hex-head” bolts; other sockets could have four sides to engage “square head” bolts. Wrenches in accordance with the present invention are not limited to only sockets for bolts. In other embodiments, surgical wrenches may include an “allen wrench” styled engagement mechanism associated with the ratcheting mechanism. In still other embodiments, surgical wrenches may include “Phillips” or flat screw driving mechanisms associated with the ratcheting mechanism. Other embodiments may include engaging mechanisms unique to the surgical fields, including AO type connectors, external/internal drive mechanisms, mechanism for use with fasteners having “Phillips star” type connections, or any other type of mechanism. In still other embodiments, the ratcheting mechanism may be modularly associated with the socket or other engaging mechanisms to allow for a wide variety sizes and shapes of engaging mechanisms to be associated with the ratcheting mechanism of a single wrench.

As indicated above, although the term “bolt” is used in various locations throughout this document, the present invention is not limited to wrenches for use with bolts, but is only a description of one embodiment. Other devices and components can also be used in conjunction with wrenches in accordance with embodiments of the present invention. For example, wrenches may be used to apply rotational force to screws, pins, other types of fasteners, or any components to which torque is to be applied in a surgical and/or orthopaedic context.

As shown best in FIG. 2, a cover plate 24 is disposed over one end of the socket 18 such that the socket 18 can only be engaged with the bolt head on one side (or face) of the wrench 10. Thus, a user would not be able to “flip” the wrench over and still engage the socket 18 to the bolt head, which would also reverse the direction of rotation allowed by the ratcheting mechanism 22. In other embodiments, the cover plate 24 is not necessary. In other embodiments, the wrench may be formed such that only one end of the socket 18 is accessible to engage the bolt head. For example, the body 12 of the wrench 10 may be formed such that the ratcheting mechanism 22 and socket 18 is located in a cavity formed in the body 12, which does not completely extend through the body 12 of the wrench 10. Wrenches may also be formed in other manners and still function in accordance with embodiments of the present invention by ensuring that the socket engages the bolt in the proper direction. In other embodiments, it is not necessary to physically block access to one side of the socket, rather, visual indicia or other means can be used to facilitate engaging the socket with the bolt from a single direction.

In the embodiment shown in FIGS. 1 and 2, when the surgical wrench 10 is engaged with the head of a bolt, the surgeon or other user can rotate the wrench 10 to apply torque to the bolt, but only in one direction. For example, if the ratcheting mechanism 22 of the wrench 10 shown in FIG. 1 is configured to allow the socket 18 to only rotate in a counter-clockwise direction, if the surgeon rotates the wrench in a counter-clockwise direction, the ratcheting mechanism 22 will allow the wrench 10 to turn freely around the socket 18 and bolt head, with little to no torque applied to the bolt. However, if the surgeon rotates this wrench embodiment in a clockwise direction, the ratcheting mechanism 22 configured for allowing only counter-clockwise rotation will not allow the socket 18 to turn freely. Rather, the ratcheting mechanism 22 will tend to force the socket 18 to rotate along with the wrench 10, which will consequently facilitate applying torque to the bolt to rotate it in a clockwise direction. Depending on the orientation of threads or other corresponding structure of the bolt and/or structure associated with the bolt, turning the bolt in a clockwise direction will tighten the bolt. It will be apparent to one skilled in the art that if the ratcheting mechanism 22 is configured such that it only facilitates the socket 18 rotating with respect to the wrench 10 in a clockwise direction, such an embodiment of a wrench 10 would function to loosen a bolt that is designed to be loosened by counter-clockwise rotation.

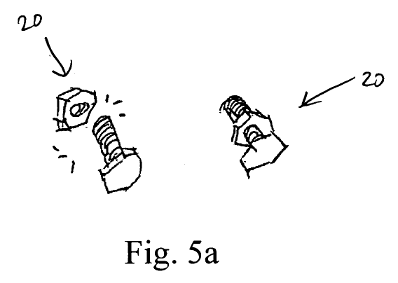

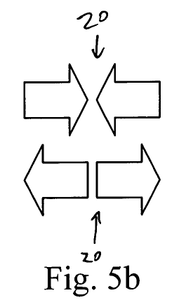

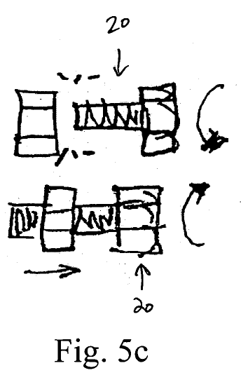

In the embodiment shown best in FIG. 1, the surgical wrench 10 includes indicia 20 for indicating that the wrench 10 will function only to tighten a bolt. In other embodiments, indicia 20 may be any desired visual indication of the function of the surgical wrench 10. FIGS. 5a, 5b and 5c show other examples of embodiments for indicating to the user whether the wrench 10 is intended for tightening or loosening of the bolt. In other embodiments, indicia 20 can take other forms that indicate the intended use of the wrench 10.

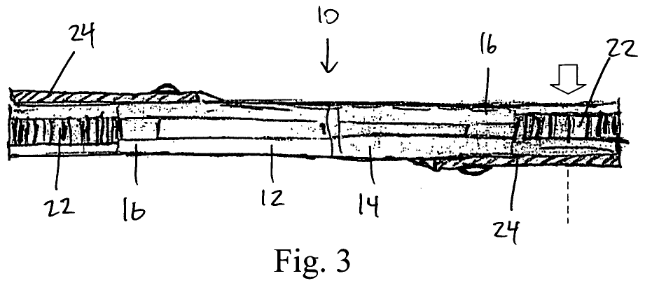

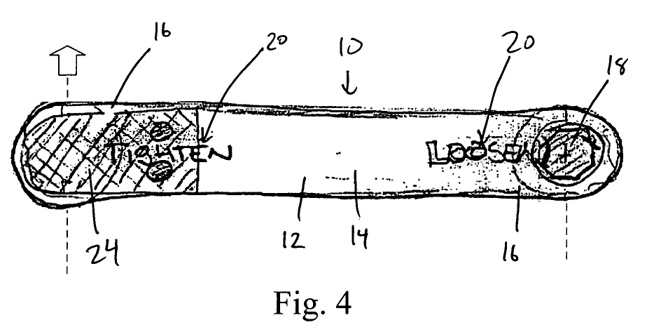

FIGS. 3 and 4 show a surgical wrench 10 according to another embodiment of the present invention. In the embodiment shown in FIGS. 3 and 4, the surgical wrench 10 includes sockets 18 for both loosening and tightening a bolt. In the embodiment shown best in FIG. 4, indicia 20 indicates to the user which end of the wrench 10 is for tightening and which end of the wrench 10 is for loosening. The “tightening” and “loosening” indicia 20 may appear on one face of the wrench 10, or may appear on both faces of the wrench, or may have only one of the “tightening” and “loosening” indicia 20 on one face and the other indicia 20 on the other face. In other embodiments, other combinations of indicia 20 may be used to indicate to the wrench's user which end is intended for which function.

In the embodiment shown in FIGS. 3 and 4, the cover plates 24 for the “tightening” and “loosening” mechanisms are on opposite sides, such that the user must flip the wrench both “over” and “around” to reorient the wrench with respect to the bolt from “tightening” to “loosening,” or vice-versa. In such embodiments, both the “tightening” and “loosening” ratcheting mechanisms 22 may be oriented to allow rotation in the same direction with respect to one face of the wrench 10. In those embodiments, because the cover plates 24 are on opposite faces of the wrench 10, one of the ratcheting mechanisms 22 and sockets will facilitate rotation of a bolt in a clockwise direction, and the other ratcheting mechanism 22 and socket 18 will facilitate rotation of the bolt in a counter-clockwise direction. In other embodiments, the ratcheting mechanisms 22 may be oriented to allow rotation in different directions from each other with respect to one fact of the wrench 10. In such embodiments, the cover plates 24 may be disposed on the same face of the wrench 10 to facilitate using one socket for clockwise rotation of a bolt and the other socket 18 for counter-clockwise rotation of a bolt.

As one example of a use of a wrench in accordance with various embodiments of the present invention, the wrench may be used in conjunction with the installation and adjustment of an external fixator. Some external fixators require the use of a relatively large number of clamps to engage pins that are set into a patient's bone. The clamps fix the positions and orientations of the pins by clamping the pins to a bar or other rigid member to set the position of a bone fracture or otherwise fix one portion of an individual's anatomy with respect to another portion. Once the surgeon has placed the pins and aligned the fracture in the desired manner, it may be desirable to rigidly affix the pins to the bar using the plurality of clamps relatively quickly to prevent undesired movement of the fractured bones or of various components of the external fixator. Wrenches in accordance with embodiments of the present invention may facilitate the quick tightening of the clamps by allowing the surgeon to quickly tighten bolts associated with those clamps in rapid succession without concern as to orienting the wrench for proper rotation of the bolts.

Additions, deletions and other changes and/or modifications may be made to the above described embodiments without departing from the scope of the present invention and the below claims.

For example, the present invention may be used not just for tightening and loosening various items, but, in some embodiments, can also be used in conjunction with other devices that are adjusted in other manners by rotation. For example, wrenches in accordance with the present invention may be used in conjunction with devices wherein various components are translated, rotated or otherwise repositioned with respect to one another by the either clockwise or counter-clockwise rotation of an adjustment mechanism. Use of wrenches in accordance with the present invention may be used with such devices to ensure that the device is adjusted in the desired manner.

As an additional alternative, wrenches in accordance with various embodiments of the present invention may be any desired type of wrench, including “closed ended” wrenches, “open ended” wrenches, “crescent” wrenches, “locking” wrenches, or any other type of wrench. In some embodiments, these wrenches may be modified to include ratcheting functionality or other functionality to ensure that the wrench applies torque to a torque member in only a single rotational direction.

1. A surgical wrench, comprising a body, the body comprising a head and a handle, at least one ratcheting mechanism disposed in the head, at least one torque member engaging mechanism associated with the ratcheting mechanism, wherein the wrench is adapted such that the torque member engaging mechanism can engage a torque member only to apply torque to the torque member in one rotational direction.
